(19) United States
(12) Patent Application Publication
(10) Pub. No.: US 2026/0040405 A1
(43) Pub. Date: Feb. 5, 2026

(54) CERAMIC POSITIVE TEMPERATURE COEFFICIENT SELF-REGULATING HEATING CABLE

(71) Applicant: nVent Services GmbH, Schaffhausen (CH)

(72) Inventors: Prasad Raut, San Jose, CA (US); Dong Yu, Fremont, CA (US); Linda D.B. Kiss, San Mateo, CA (US); William Edward Jarvis, Millbrae, CA (US); Jimmy Wang, Hillsborough, CA (US); Wade DePolo, Sunnyvale, CA (US)

(21) Appl. No.: 19/287,640

(22) Filed: Jul. 31, 2025

Related U.S. Application Data
(60) Provisional application No. 63/678,121, filed on Aug. 1, 2024.
(60) Provisional application No. 63/709,958, filed on Oct. 21, 2024.

(51) Int. Cl. H05B 1/02; H05B 3/56

(52) U.S. Cl. CPC H05B 1/0202; H05B 3/56

(57) ABSTRACT

Self-regulating heating cables and associated production methods are provided. A self-regulating heating cable includes a first frame element coupled to a first conductive wire, with a first chip tab that extends from the first frame element toward a second conductive wire at least to a midpoint between the first and second conductive wires. A second frame element is coupled to the second conductive wire, with a second chip tab that extends from the second frame element toward the first conductive wire. A ceramic positive temperature coefficient (PTC) chip is disposed between the first conductive wire and the second conductive wire, and is retained between the first conductive wire and the second conductive wire by the first chip tab and the second chip tab.

### CROSS REFERENCE TO RELATED APPLICATIONS

This application claims priority to U.S. Provisional Application No. 63/678,121, filed on Aug. 1, 2024, and to U.S. Provisional Application No. 63/709,958, filed on Oct. 21, 2024, the contents of which are incorporated by reference herein in its entirety.

### BACKGROUND

Heating cables, such as self-regulating heating cables, tracing tapes, and other types, are cables configured to provide heat in applications requiring such heat. Heating cables offer the benefit of being field-configurable. For example, heating cables may be applied or installed as needed without the requirement that application-specific heating assemblies be custom-designed and manufactured, though heating cables may be designed for application-specific uses in some instances.

In some approaches, a heating cable operates by use of two or more bus wires having a high conductance coefficient (i.e., low resistance). The bus wires are coupled to differing voltage supply levels to create a voltage potential between the bus wires. A positive temperature coefficient (PTC) material can be situated between the bus wires and current is allowed to flow through the PTC material, thereby generating heat by resistive conversion of electrical energy into thermal energy. As the temperature of the PTC material increases, so does its resistance, thereby reducing the current therethrough and, therefore, the heat generated via resistive heating. The heating cable is thus self-regulating in terms of the amount of thermal energy (i.e., heat) output by the cable.

### SUMMARY

Some embodiments provide a self-regulating heating cable including a first conductive wire and a second conductive wire. The cable includes a first frame element coupled to the first conductive wire, including a first chip tab that extends from the first frame element toward the second conductive wire at least to a midpoint between the first and second conductive wires. A second frame element is coupled to the second conductive wire, and includes a second chip tab that extends from the second frame element toward the first conductive wire. A ceramic positive temperature coefficient (PTC) chip is disposed between the first conductive wire and the second conductive wire. The PTC chip is retained between the first conductive wire and the second conductive wire by the first chip tab and the second chip tab.

Some embodiments provide a self-regulating heating cable including a first conductive wire and a second conductive wire. The cable includes a first frame element coupled to the first conductive wire, including a first chip tab, and a second frame element coupled to the second conductive wire, including a second chip tab. A ceramic positive temperature coefficient (PTC) chip is disposed between and electrically coupled to the first conductive wire and the second conductive wire. The PTC chip is retained between the first conductive wire and the second conductive wire by the first chip tab and the second chip tab, and the first or second chip tab automatically electrically disconnects from the first or second frame element, respectively, in response to a condition.

Some embodiments provide a method of producing a self-regulating heating cable for use with an alternating current (AC) source. The method includes aligning a first frame element along a first conductive wire, with the first conductive wire including a first axis extending through a center thereof, and aligning a second frame element along a second conductive wire that is positioned parallel to the first conductive wire. The method also includes coupling the first frame element to the first conductive wire, coupling the second frame element to the second conductive wire, arranging a first chip tab of the first frame element to extend from the first frame element toward the second conductive wire at least to a midpoint between the first and second conductive wires, and arranging a second chip tab of the second frame element to extend from the second frame element toward the first conductive wire at least to the midpoint between the first and conductive second wires. The method further includes placing a ceramic positive temperature coefficient (PTC) chip between the first and second chip tabs of the first and second frame elements.

### DESCRIPTION OF THE DRAWINGS

FIG. 1 is an isometric cutaway view a self-regulating heating cable according to some embodiments.

FIG. 2 is an enlarged view of the self-regulating heating cable of FIG. 1, taken at section 2 of FIG. 1.

FIG. 3 is a partial exploded view of the self-regulating heating cable of FIG. 1.

FIG. 4 is a cross-sectional view of the self-regulating heating cable of FIG. 1, taken along line 4-4 of FIG. 1.

FIG. 5 is a partial elevation cutaway view of the self-regulating heating cable of FIG. 1.

FIG. 6 is another elevation cutaway view of the self-regulating heating cable of FIG. 1.

FIG. 7 is a behavioral temperature versus resistance graph of a self-regulating heating cable according to some embodiments.

FIG. 8 is a behavioral temperature versus power output graph of a self-regulating heating cable according to some embodiments.

FIG. 9 is a method for a manufacturing self-regulating heating cable according to an example implementation.

FIG. 10 is an isometric cutaway view a self-regulating heating cable according to some embodiments.

FIG. 11 is an enlarged view of the self-regulating heating cable of FIG. 1, taken at section 11 of FIG. 10.

FIG. 12 is a cross-sectional view of the self-regulating heating cable of FIG. 10, taken along line 12-12 of FIG. 10.

FIG. 13 is a partial exploded view of the self-regulating heating cable of FIG. 10.

FIG. 14 is an elevation cutaway view of the self-regulating heating cable of FIG. 10 in a first configuration.

FIG. 15 is another elevation cutaway view of the self-regulating heating cable of FIG. 10 in a second configuration.

FIG. 16 is an enlarged cutaway view of a self-regulating heating cable according to some embodiments.

FIG. 17 is a method for a manufacturing self-regulating heating cable according to an example implementation.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Generally, self-regulating heating cables can include a positive temperature coefficient (PTC) material that is situated between a set of bus wires. Many conventional heating cables embed or otherwise retain and suspend the PTC material between the bus wires using perfluoroalkyl or polyfluoroalkyl substances (PFAS). Examples of the disclosed technology, on the other hand, provide a self-regulating heating cable that is free of PFAS. For example, through the use of ceramic PTC chips that are suspended between bus wires using a frame, the heating cables described below can provide efficient and reliable thermal output, without the use of PFAS or other polymer-based PTC material. Additionally, examples herein further provide switch mechanisms to selectively electrically disconnect the PTC chips from one or more of the bus wires to mitigate thermal runaway or overheating during operation of the heating cables.

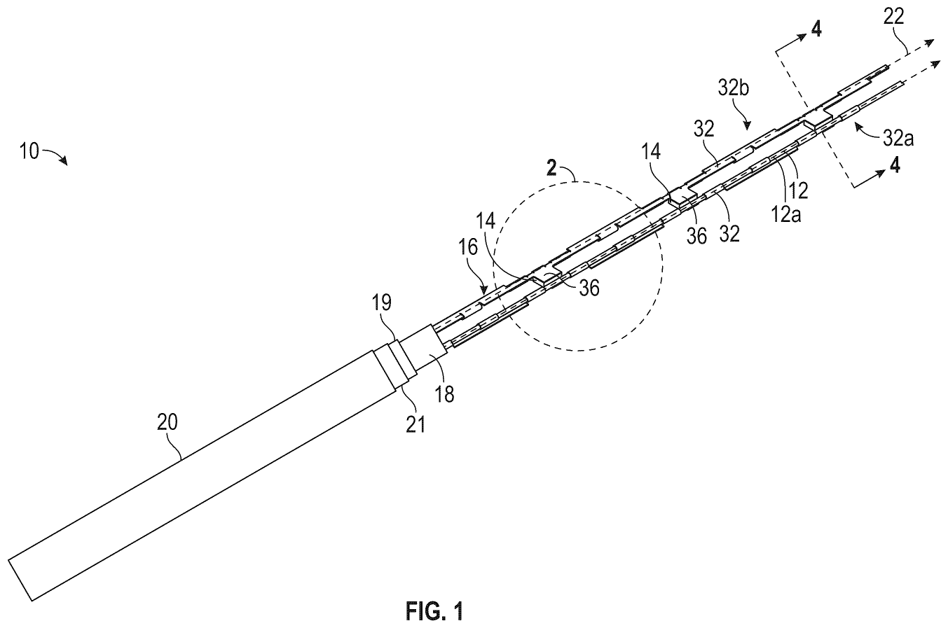

FIG. 1 illustrates a self-regulating heating cable 10 according to some embodiments. As shown in FIG. 1, the cable 10 can include parallel conductor wires 12, a plurality of positive temperature coefficient (PTC) chips 14, a frame 16, a primary jacket 18, a final jacket 20, and an optional barrier layer 19 and/or a ground plane 21 disposed between the primary jacket 18 and the final jacket 20.

In some embodiments, a center axis 22 can extend through a center of each of the conductor wires 12. The center axis 22 can extend from a first end of the conductor wires to a second end of the conductor wires axially opposite the first end. As described further below, the frame 16, the primary jacket 18, the final jacket 20, and the optional barrier layer 19 and/or the ground plane 21 can extend axially along the center axes 22 and can further extend around the center axes 22 to surround the conductor wires 12.

In some embodiments, the conductor wires 12 can be made of nickel-coated copper or other conductive material. Furthermore, in some embodiments, each of the conductor wires 12 can be a solid metal conductor or can include braided wire or braided wire bundles. The conductor wires 12 can extend along a length of the heating cable 10 and can be parallel and spaced apart at a width equivalent to a width of the PTC chips 14, or at a width that is larger than the width of the PTC chips 14.

The PTC chips 14 can be sized to fit between the conductor wires 12. In some examples, the PTC chips 14 can contact each of the conductor wires 12, thus providing an electrical path between the conductor wires 12. However, as described below, the PTC chips 14 may not directly contact the conductor wires 12, but may otherwise be electrically connected to the conductor wires 12.

The PTC chips 14 may function as resistive heaters, converting electrical energy into thermal energy as current flows through the PTC chips 14. In some examples, a resistance of the PTC chips 14 can change as the temperature of the PTC chips 14 changes, thereby providing self-regulating heating capabilities to the cable 10. However, the PTC chips 14 may instead exhibit a constant resistance in some applications. Additionally, in some implementations, the PTC chips 14 can be made of a ceramic material or another non-polymer material in combination with additives that provide the PTC chip with its PTC properties, and, optionally, additional additives. However, in other examples, the PTC chips 14 can comprise any applicable combination of materials that may form a heating element.

As shown in FIG. 1, the PTC chips 14 can be spaced apart along a length of the heating cable 10. In some examples, the PTC chips 14 can be equispaced along the heating cable 10, or along the axes 22. For example, a distance between adjacent chips of the PTC chips 14 may be consistent. However, in other examples, a spacing between the PTC chips 14 can vary. For example, one or more sections of the heating cable 10 may include more or less of the PTC chips 14 to configure heating profiles and properties of the heating cable 10. Furthermore, in some embodiments, this spacing may be closer together or further apart than what is illustrated in the figures.

The frame 16 can be made of a conducting material (e.g., electrically conducting material), such as a metal (e.g., aluminum, copper, or other conducting metal), or other conducting material. As described further below, the frame 16 can be coupled to or otherwise hold the conductor wires 12. Furthermore, in some examples, the coupling of the frame 16 to the conductor wires 12 can both mechanically and electrically couple the frame to the conductor wires 12. In some implementations, on the other hand, the frame 16 may be made of a non-conductive material, such as a non-conductive, inorganic material and, thus, only serves as a mechanical coupling.

In some examples, the frame 16 can be semi-rigid. In such examples, the frame 16 can hold a position or orientation of the wires 12, and can help to maintain a shape (e.g., coiled or elongated) of the cable 10 during transportation and after installation. In other examples, the frame 16 can be flexible, and can be secured to the wires 12, but may otherwise allow the wires 12 to be easily rolled, coiled, or otherwise flexed.

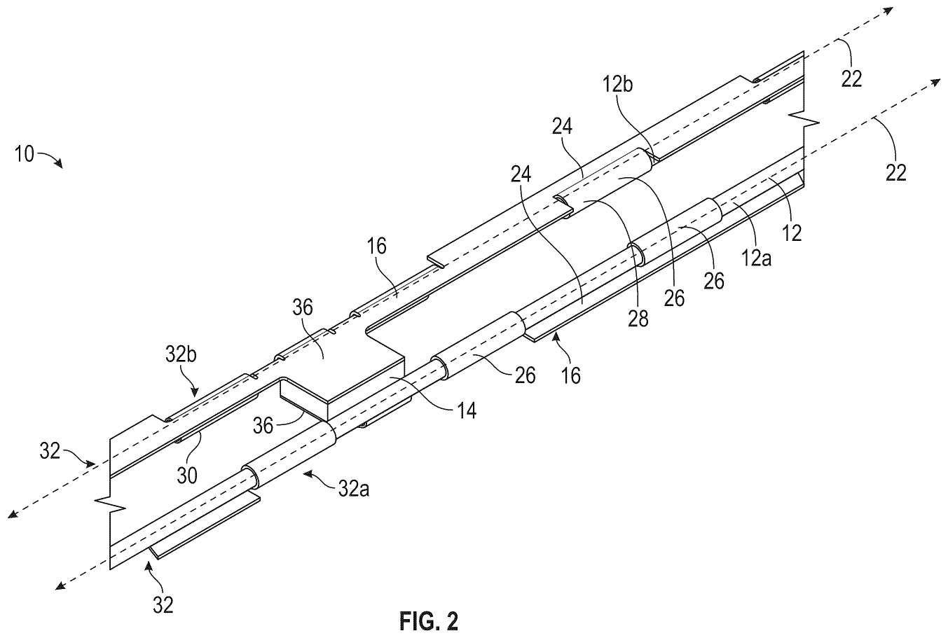

As shown in FIG. 1, and with further reference to FIG. 2, in some embodiments, the frame 16 can include a plurality of frame elements 32, such as a first frame element 32a associated with a first conductor wire 12a and a second frame element 32b associated with a second conductor wire 12b. More specifically, the first frame element 32a can extend axially along the center axis 22 of the first conductor wire 12a and be coupled to the first conductor wire 12a, and the second frame element 32b can extend axially along the center axis 22 of the second conductor wire 12a and be coupled to the second conductor wire 12b. As such, the frame elements 32a, 32b may extend parallel to each other along the center axes 22. In some examples, each of the frame elements 32a, 32b can extend continuously from the first end of the wires 12a, 12b to the second end of wires 12a, 12b. By providing a continuous construction of the frame elements 32a, 32b, the frame 16 can be manufactured in long continuous lengths, allowing the frame 16 or the cable 10 to be cut to length for a particular application. However, in other examples, the frame elements 32a, 32b may be manufactured and arranged in discontinuous segments or sections along the wires 12a, 12b, which may also potentially ease manufacturing and installation of the frame 16 within the cable 10 as well as flexibility of the cable 10.

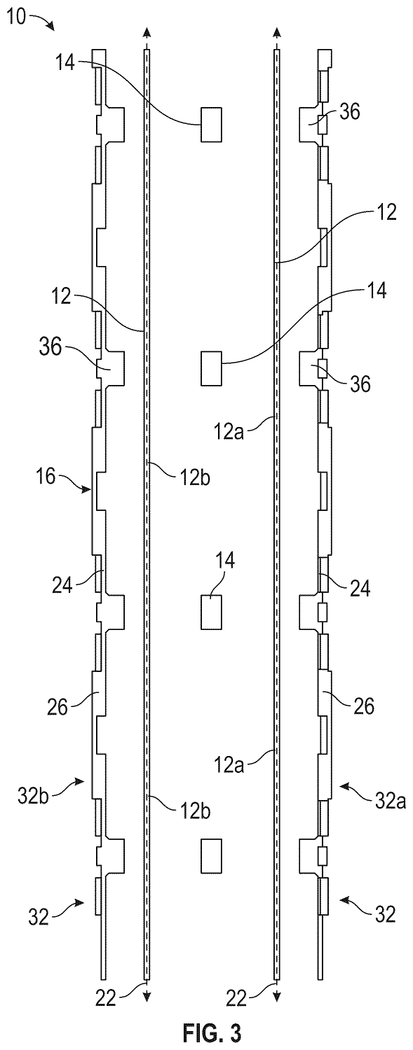

As described above, the frame 16 can extend along to the wires 12. For example, as illustrated in FIGS. 2 and 3, each of the frame elements 32 can include a stem 24 that extends parallel to the conductor wires 12 (e.g., to the center axes 22 thereof). More specifically, the stems 24 of the frame elements 32 can extend continuously along the wires 12. However, in other examples, the stems 24 may instead be discontinuous and can include a plurality of sections that extend along the wires 12. The stems 24 may directly contact the wires 12 to form an electrical pathway between the stems 24 and the wires 12. However, as described below, the stems 24 may otherwise or further be electrically and/or mechanically coupled to the wires 12.

As described above, the frame 16 can be mechanically and/or electrically secured to the wires 12. In some examples, one or more securement tabs 26 may extend from the stems 24 of each of the frame elements 32 to secure the frame element 32 to a respective wire 12. More specifically, a plurality of the securement tabs 26 may extend from the frame elements 32, or individual sections thereof, such that the frame elements 32, or individual sections thereof, extend continuously between two or more of the securement tabs 26 (e.g., between three, four, five, or more of the securement tabs 26). In such examples, the securement tabs 26 may be spaced along the frame elements 32, and axially offset from one another along a respective one of the center axes 22. Spacing the securement tabs 26 may increase the flexibility of the frame 16 and, therefore, of the heating cable 10.

In some examples, the securement tabs 26 can be equispaced along the frame elements 32, or along the axes 22. For example, a distance between adjacent tabs of the securement tabs 26 may be consistent. However, in other examples, a spacing between the securement tabs 26 can vary, or securement tabs 26 can be arranged side-by-side along the frame elements 32. In such examples, one or more sections or segments of the heating cable 10 may include more or less of the securement tabs 26 to configure flexibility or other mechanical properties of the heating cable 10.

The securement tabs 26 of each of the frame elements 16 may be bent, crimped, or otherwise mechanically manipulated to couple the securement tabs 26 to the wires 12. In one example, the securement tab 26 may at least partially surround a respective one of the conductor wires 12, to secure the frame element 32 to the respective conductor wire 12 and hold the conductor wire 12 in place. The securement tabs 26 can be made of an electrically conductive material (e.g., similar to or identical to a material of the stem 24). In such examples, the securement tabs 26 may mechanically and electrically couple the frame elements 32 to the wires 12 and form an electrical pathway therebetween. In some examples, the securement tabs 26 can extend integrally from the stems 24 to couple the wires 12. However, in other examples, the securement tabs 26 can be coupled to the stems 24 via one or more securement mechanisms such as a weld, solder, a hinge, or other securement mechanism.

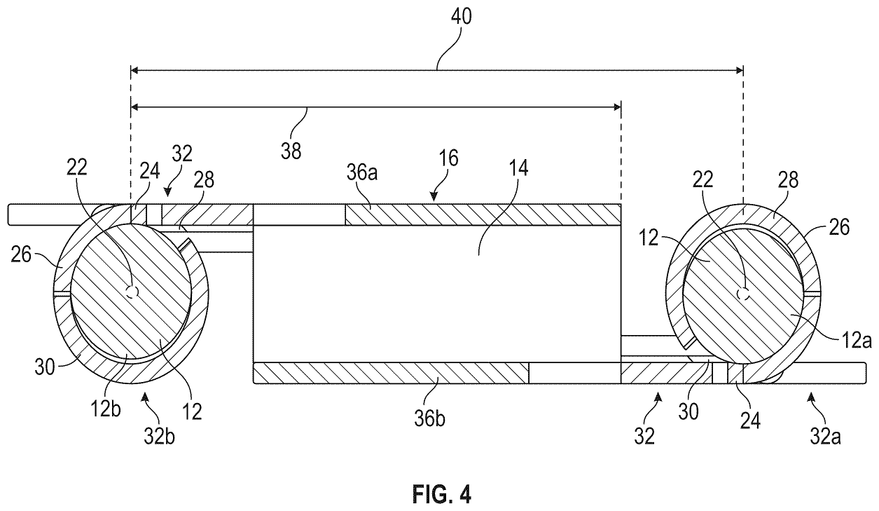

Referring to the cross-sectional view of FIG. 4, in some examples, each frame element 32 includes a first set 28 of the securement tabs 26 extending from a first side of the frame element 32, and a second set 30 of the securement tabs 26 extending from a second side of the frame element 32 that is opposite the first side. The first and second sets 28, 30 of the securement tabs 26 disposed on opposite sides of the frame element 32 may thus allow the first and second sets 28, 30 of the securement tabs 26 to contact opposing (e.g., radially opposing relative to the center axis 22) surfaces of a respective wire 12. Furthermore, the first and second sets 28, 30 of the securement tabs 26 can be crimped, bent, or otherwise mechanically manipulated to extend in opposing rotational directions (e.g., counterclockwise and clockwise) around the wire 12 (e.g., counterclockwise and clockwise about the center axis 22). The opposing engagement of the sets 28, 30 of the securement tabs 26 on each wire 12 allows the frame element 32 to better secure and retain the wire 12. In such examples, the sets 28, 30 of the securement tabs 26 may cooperatively extend around an entire circumference of the wire 12. For example, each of securement tabs 26 may extend around more than about 50%, more than about 70%, or more than about 90% of the circumference of the wire 12. In some examples, each of the frame elements 32a, 32b can include multiple of the sets 28, 30 of the securement tabs 26. Furthermore, each of the frame elements 32a, 32b may similarly engage a respective one of the wires 12a, 12b using the sets 28, 30 of the securement tabs 26.

Referring to FIGS. 1-4, a heat generating core of the self-regulating heating cable 10 includes the conductor wires 12 and the PTC chips 14. As described further below, current flowing through the conductor wires 12 may be delivered to the PTC chips 14 (e.g., via the frame 16), causing the core of the self-regulating heating cable 10, specifically the PTC chips 14, to generate thermal energy. In some examples, the heat generating core of the self-regulating heating cable 10 can be supported by the frame 16, as well as other components of the cable 10, to help maintain an electrical pathway between the wires 12 and the PTC chips 14.

In some examples, the frame 16 may further be utilized to secure the PTC chips 14 between the wires 12. Additionally, the frame 16 may provide a path for current to flow between the conductor wires 12 and the PTC chips 14. Referring to FIGS. 1-4, in some examples, each frame element 32 may include a plurality of chip tabs 36 that can be utilized to mechanically and electrically couple the PTC chips 14 to the frame 16. The chip tabs 36 extend from the stem 24 to secure the PTC chips 14 to the frame 16 and, in turn, to the wires 12. The chip tabs 36 may extend from the first side of each of the frame elements 32. For example, the chip tabs 36 can extend integrally from each of the stems 24. As a result, in some examples, each frame element 32 can comprise a single piece of conductive material that is stamped or otherwise cut to integrally form the stem 24, the securement tabs 26, and the chip tabs 36. However, as described further below in other examples, the chip tabs 36 can be a separate conductive material that is coupled to the stems 24 via one or more securement mechanisms such as a weld, solder, a hinge, a fuse, a switch, or another securement mechanism.

The chip tabs 36 of each of the frame elements 32 may be bent, crimped, or otherwise mechanically manipulated to contact and cooperatively suspend one or more of the PTC chips 14 between the wires 12. More specifically, the chip tabs 36 extending from the first frame element 32a can extend from the first frame element 32a toward the second wire 12b. Furthermore, the chip tabs 36 extending from the second frame element 32b can extend from the second frame element 32b toward the first wire 12a. In some examples, with reference to FIG. 4, the chip tabs 36 (e.g., a first chip tab 36a of the first frame element 32a and a second chip tab 36b of the second frame element 32b) can extend a chip tab distance 38 from the respective frame elements 32a, 32b. For example, the chip tab distance 38 can be about the same as a wire distance 40 measured radially from the center axes 22 between the wires 12a, 12b. In such examples, a ratio of the chip tab distance 38 to the wire distance 40 can be about 1:1. However, in other examples the ratio of the chip tab distance 38 to the wire distance 40 can be more than about 3:4, or more than about 2:3, or more than about 1:2. In such examples, the chip tabs 36 of the first frame element 32a can extend from the first frame element 32a toward the second wire 12b at least to a midpoint between the first and second wires 12a, 12b, or past the midpoint. Similarly, the chip tabs 36 of the second frame element 32b can extend from the second frame element 32b toward the first wire 12b at least to the midpoint between the first and second wires 12a, 12b, or past the midpoint.

In some examples, the chip tabs 36 of the first frame element 32a and the chip tabs 36 of the second frame element 32b may cooperatively retain the PTC chips 14. For example, one or more of the chip tabs 36 of the first frame element 32a may cooperatively retain one of the PTC chips 14 with one or more of the chip tabs 36 of the second frame element 32b. In some examples, each of the chip tabs 36 of the first frame element 32a may be matched with one of the chip tabs 36 of the second frame element 32a to cooperatively retain one of the PTC chips 14. For example, still referring to FIG. 4, the first chip tab 36a of the first frame element 32a may cooperatively retain one of the PTC chips 14 with the second chip tab 36b of the second frame element 32b. In such examples, the chip tabs 36a, 36b may extend parallel to one another and may be axially aligned with one another along the axes 22. Furthermore, a distance between the chip tabs 36a, 36b can be about equal to a thickness of one of the PTC chips 14. In such examples, the chip tabs 36a, 36b may sandwich one of the PTC chips 14 between the chip tabs 36a, 36b. Specifically, the PTC chip 14 can be contacted on opposing sides by the chip tabs 36a, 36b. In some examples, the chip tabs 36a, 36b may sandwich one of the PTC chips 14, such that an axis extending perpendicular to the chip tabs 36a, 36b, from a center of one the chip tabs 36a, 36b may intersect the other of the chip tabs 36a, 36b. In other examples, the chip tabs 36a, 36b may sandwich one of the PTC chips 14, such that an axis extending perpendicular to the chip tabs 36a, 36b, from a free end of one the chip tabs 36a, 36b (e.g., opposite a respective frame element 32) may intersect the other of the chip tabs 36a, 36b. In some aspects, this alignment allows the chip tabs 36 to securely hold the PTC chips 14 in place between the frame elements 32a, 32b. Furthermore, the sandwiching arrangement may help maintain consistent contact between the PTC chips 14 and the chip tabs 36, which in turn may facilitate reliable electrical pathways between the PTC chips 14 and the chip tabs 36 (e.g., through a vertical thickness of the PTC chip 14, with reference to FIG. 4). In some examples, each of the pairings of chip tabs 36 that cooperatively receive one of the PTC chips 14 may be configured similarly or identical to the chip tabs 36a, 36b shown in FIG. 4.

In some examples, the spacing between each pairing of chip tabs 36 (e.g., the chip tabs 36a, 36b) may be adjustable to accommodate the PTC chips 14 of varying thicknesses or to apply a specific amount of pressure to the PTC chips 14. In some examples, a shape and size of the chip tabs 36 may be similar or identical to a shape of the PTC chips 14. Matching the shape and size of the chip tabs 36 and the PTC chips 14 may enhance a surface area that provides the electrical pathways between the PTC chips 14 and the chip tabs 36. That is, with reference to FIG. 4, an entire (or substantially entire) “top surface” of the PTC chip 14 is in contact with the first chip tab 36a, and an entire (or substantially entire) “bottom surface” of the PTC chip 14 is in contact with the second chip tab 36b. In the example of FIG. 4, the “side surfaces” of the PCT chip 14 (e.g., the surfaces closest to the axes 22) may not be contact by the chip tabs 36. However, in some implementations, a chip tab 36 may contact both a top or bottom surface, as well as a side surface of a PTC chip 14.

In some examples, the chip tabs 36 may be spaced from one another along the frames 16. For example, the chip tabs 36 can be spaced apart along a length of the heating cable 10. In some examples, the chip tabs 36 can be equispaced along the heating cable 10, or along the axes 22. For example, a distance between adjacent tabs of the chip tabs 36 may be consistent. However, in other examples, a spacing between the chip tabs 36 can vary. For example, one or more sections of the heating cable 10 may include more or less of the chip tabs 36. In such examples, regardless of the spacing of the chip tabs 36, each of the chip tabs 36 along the first frame element 32a may cooperatively receive one of the PTC chips 14 with a corresponding chip tab 36 along the second frame element 32b. Furthermore, in some embodiments, the spacing between chip tabs 36 may be closer together or further apart than what is illustrated in the figures. Spacing the chip tabs 36 may increase the flexibility of the frames 16 and therefore the heating cable 10. Additionally, in some implementations, selectively spacing the chip tabs 36 may affect the power output of the heating cable 10.

In some examples, the chip tabs 36 may include interlocking or mating features. For example, the chip tabs 36a, 36b may include interlocking features that help to secure the chip tabs 36a, 36b to the PTC chip 14 and to one another. In other examples, a tape (e.g., Kapton tape, not shown) can be wrapped around the PTC chips 14 and chip tabs 36 once assembled to further prevent axial movement of the PTC chips 14 within the frame 16 (e.g., along a length of the cable 10 or along the axes 22). Alternatively or additionally, in some embodiments, the PTC chips 14 and chip tabs 36 can be mechanically held in place by a crimp-like or clipping mechanism or can be bonded together with an adhesive. Furthermore, in some embodiments, wrapping tension of the primary jacket 18 can further help retain the PTC chips 14 in place.

In some examples, the chip tabs 36 may be spaced from the securement tabs 26 along the frames 16. For example, the chip tabs 36 can be axially offset from the securement tabs 26 along the center axes 22. In some examples, a plurality of the securement tabs 26 can be disposed between adjacent tabs of the chip tabs 36. In some examples, the number of securement tabs 26 may vary based on a desired flexibility of the frames 16 and therefore the heating cable 10, or based on other factors such as a size of the PTC chips 14 or a size of the chip tabs 36. Furthermore, in some embodiments, the spacing between the chip tabs 36 and the securement tabs 26 may be closer together or further apart than what is illustrated in the figures.

As described above, the chip tabs 36 may comprise a conductive material (e.g., a material similar to the material of the frame 16). However, the chip tabs 36 may instead comprise any conductive material (e.g., metal or other conductive material). The coupling between the chip tabs 36 and the frame elements 32 may therefore advantageously create an electrical pathway between the frame elements 32 and the chip tabs 36, as well as between the wires 12 and the chip tabs 36. As such, the chip tabs 36 may be considered electrode plates that connect the frame 16 to the PTC chips 14.

Accordingly, an electrical pathway may connect the wires 12 and the chip tabs 36. As such, current may be conducted to and through the PTC chips 14 retained by the chip tabs 36. Specifically, placing the PTC chips 14 between respective chip tabs 36 of the frame elements 32 can cause the PTC chip 14 to be electrically connected to the wire 12 via the chip tabs 36 and the frame elements 32. As a result, current may be allowed to flow between the wires 12 through the PTC chips 14 (e.g., via the frame elements 32 and the chips tabs 36). The flow of current between the conductive wires 12, through the PTC chips 14, may generate heat by resistive conversion of electrical energy into thermal energy when voltage from a power source (not shown) is applied to the wires 12.

In light of the above, the PTC chips 14 can locally generate thermal energy at a plurality of locations along a length of the cable 10 that can be transferred to the ambient environment. In some examples, the PTC chips 14 may be separated from one another along the cable 10 by about three inches. However, in other embodiments, the PTC chips 14 may be separated by a distance that is between about 0.5 inches and about eight inches, or between about one inch and about six inches, or between about two inches and about five inches. As noted above, the separation of the PTC chips 14 and the chip tabs 36 may aid the control of the generation and dispensation of thermal energy along the cable 10.

Additionally, in some examples, silicone or some other filler material may be utilized to fill empty space between the frames 16, e.g., not occupied by the PTC chips 14. Reducing the presence of air by incorporating silicon or another filler material may aid the distribution of thermal energy along the self-regulating heating cable 10, as well as to the ambient environment. The silicone may also strengthen the connection that couples the PTC chips 14 to the chip tabs 36 and therefore to the wires 12.

In some examples, the conductor wires 12, the PTC chips 14, and the frame 16 can be surrounded by the primary jacket 18, which can be an electrically insulating compound. In some embodiments, the primary jacket 18 can be a foil, tape, a glass, or other inorganic material. On top of the primary jacket 18, the optional barrier layer 19 can act as a barrier for the interior components (e.g., protecting them from water and/or chemicals). The barrier layer 19 can be a metallic foil, such as aluminum foil. The ground plane 21 (e.g., a tinned-copper, nickel plated copper, or other metallic braid or wrap) can then surround the aluminum foil barrier layer 19 or the primary jacket 18 and acts as a ground path. On top of the ground plane 21 (or primary jacket 18), the final jacket 20 acts as a mechanical protection layer.

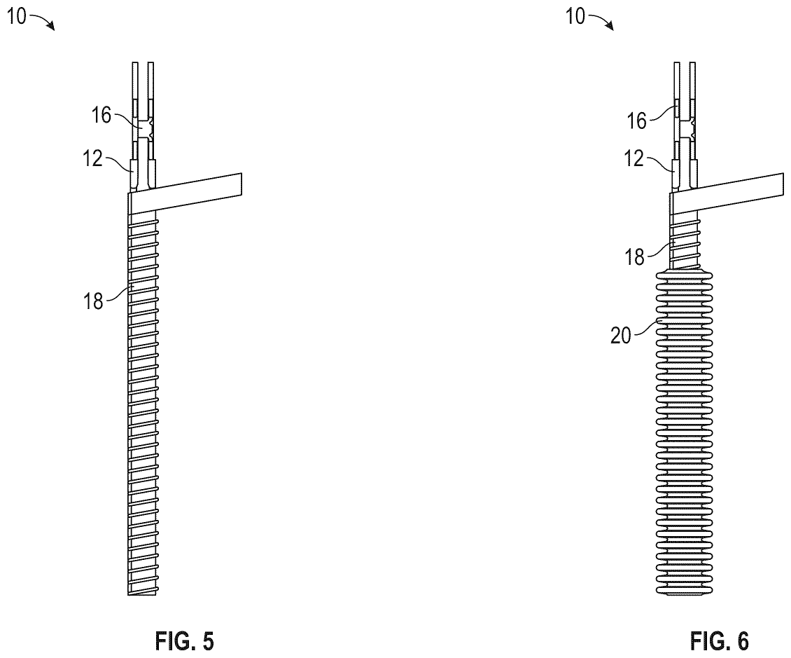

For example, referring to FIGS. 5 and 6, the primary jacket 18 and the final jacket 20 may be made of an inorganic or non-polymer material. For example, the primary jacket 18 may be made of glass tape, mica, silica, glass yarn, metallic tubing, or other inorganic materials. Additionally, the final jacket 20 may be made of a metallic tubing, such as smooth or corrugated metallic tubing in some embodiments and acts as a ground path. The inorganic or non-polymer materials of the primary and final jackets 18, 20 may aid the distribution of thermal energy along lengths of the self-regulating heating cable 10, as well as to the ambient environment. The inorganic materials of the primary and final jackets 18, 20 may consequently aid the reduction of cold spots along the heating cable 10. However, it is appreciated that the primary jacket 18 and the final jacket 20 may also be polymers or some other organic material in some embodiments.

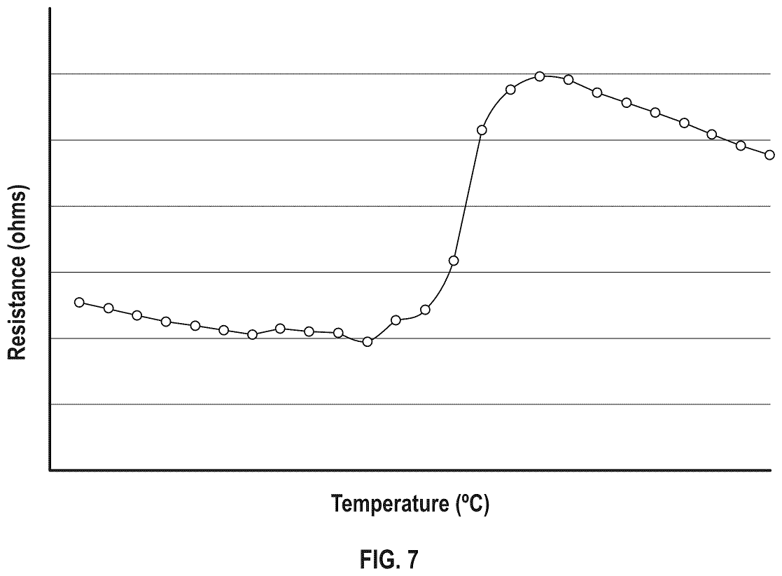

FIG. 7 illustrates a chart of a resistive behavior of an example PTC chip 14. As illustrated, the PTC chip 14 showcases higher resistance at very low temperatures, which could advantageously benefit cold startup of the heating cable 10. Additionally, similar to conventional PTC materials, the resistance of the PTC chips 14 showcases a general upward trend as the temperature of the PTC chips 14 is increased. Furthermore, ceramic PTC chips 14 can allow for the cable 10 to reach the same maximum continuous exposure levels as that of conventional high temperature self-regulating cables with PFA cores. For example, in some applications, the cable 10 of some embodiments, incorporating the ceramic PTC core, can reach a maximum continuous exposure level of 205 degrees Celsius, or above. Furthermore, coupling the ceramic heater core with non-organic jacketing material, as described above, can allow higher intermittent exposure temperature, e.g., of up to 260 degrees Celsius, or above. For example, the present cable 10, incorporating the ceramic, nonpolymeric core and inorganic jacketing, can have a higher temperature limit than the limits of conventional polymeric cables, which are based on the temperature limits of polymeric resins in use.

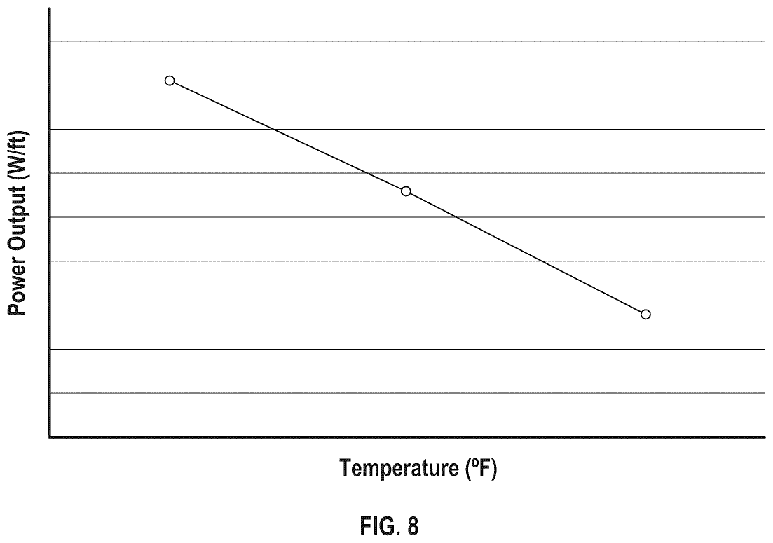

Looking now to FIG. 8, a power output behavior of an example heating cable 10 of some embodiments is shown. The power vs. temperature graph in FIG. 8, based on an applied voltage of 220 volts, indicates that the ceramic PTC chips 14 may showcase a self-regulating behavior, where power output of the cable 10 decreases with an increase in substrate temperature. In some applications, the power output of the heating cable 10 can be varied by altering the size of the PTC chips 14, the resistance of the PTC chips 14, the spacing of the PTC chips 14, and/or a pitch (e.g., angle) of PTC chips 14, relative to the frame 16. For example, the behavior of the cable 10 could be altered by angling the PTC chips 14 obliquely relative to the frames 16 or the center axes 22 of the wires 12.

In one embodiment, each PTC chip 14 may be a rectangular prism that is about 10 millimeters (mm)×about 6 mm×about 2 mm, with a resistance between about 1 kiloohm (Kohm) and about 1.5 Kohms. However, as described above, the behavior of the PTC chips 14 may be altered by altering a shape of the PTC chips 14 in some applications. As such, the PTC chip 14 may be longer, shorter, thicker, or otherwise a different dimension to alter characteristics thereof. Additionally, the PTC chip 14 may be any three-dimensional shape including a cylinder, cube, triangular prism, pyramid, or other relevant 3-D shape.

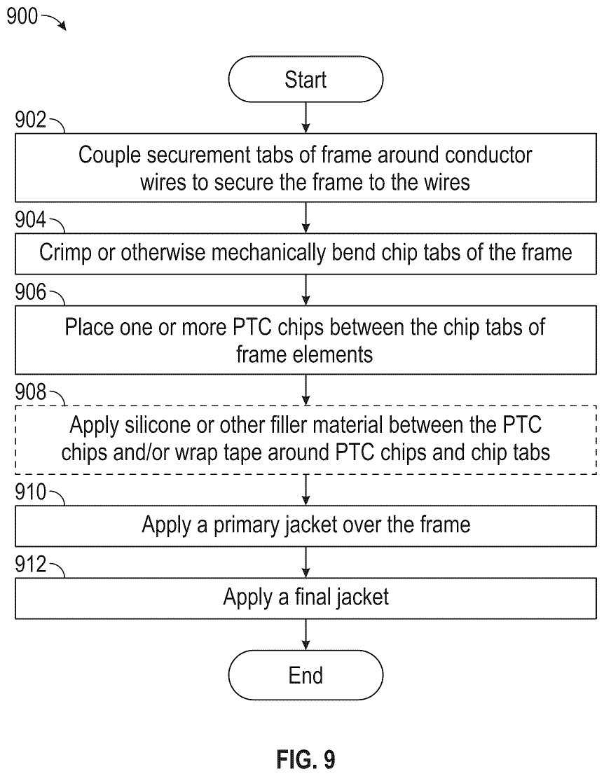

In light of the above, FIG. 9 illustrates an example method 900 for manufacturing the cable 10 of some embodiments. It should be noted that, while the method in FIG. 9 is shown and described as having certain method steps in a specific order, in some implementations, the method may include fewer or more steps, steps that are repeated, steps in a different order, and/or two or more steps performed simultaneously.

Referring to FIG. 9, at step 902, the method 900 can include coupling (e.g., via crimping, bending, or other coupling technique) securement tabs 26 of the frame elements 32 around a plurality of wires 12, such as a pair of wires 12, to secure (e.g., mechanically fasten) the frame 16 to the wires 12. For example, as noted above, in some implementations, each securement tab 26 can be bent around a respective wire 12, and axially adjacent securement tabs 26 may be bent around the wire 12 in opposite directions. Additionally, in some applications, prior to step 902, an initial frame preparation step can include preparing frame elements 32. For example, such as step can include stamping a material to form an unbent frame element 32, including the stem 34 and flat securement tabs 26 and chip tabs 36 extending from the stem 34. In some applications, the opposing frame elements 32a, 32b may be identical but flipped (e.g., mirror image) so that the same forming process can be used to make all frame elements 32.

Referring still to FIG. 9, at step 904, the method 900 can include crimping or otherwise mechanically bending or arranging chip tabs 36 of the frame elements 32. At step 906, the method 900 can include placing one or more PTC chips 14 between the chip tabs 36 of opposing frame elements 32. During step 906, the chip tabs 36 of the frame elements 32 may be further adjusted and aligned so that the chip tabs 36 can properly retain the PTC chips 14.

In some embodiments, steps 902-906 can be completed in an assembly line-type operation. At step 908, the method 900 can optionally include applying silicone or another filler material in the spacing between PTC chips 14. Furthermore, step 908 can optionally or additionally include wrapping the chip tabs 36 and embedded PTC chips 14 with a Kapton tape.

At step 910, the method 900 can include applying a primary jacket 18 over the frame 16. For example, during step 910, the primary jacket 18 can be a tape or other wrappable material that is wrapped around the frame 16. At step 912, the method 900 can include applying a final jacket 20. For example, during step 912, the assembly including at least the wires 12, the PTC chips 14, the frame 16, and the primary jacket 18 can be pulled through the final jacket 20. In some applications, prior to step 912, the method 900 can further include applying a barrier layer 19 (e.g., metallic foil) and/or a ground plane layer 21 (e.g., metallic braid or wrap) around the primary jacket 18.

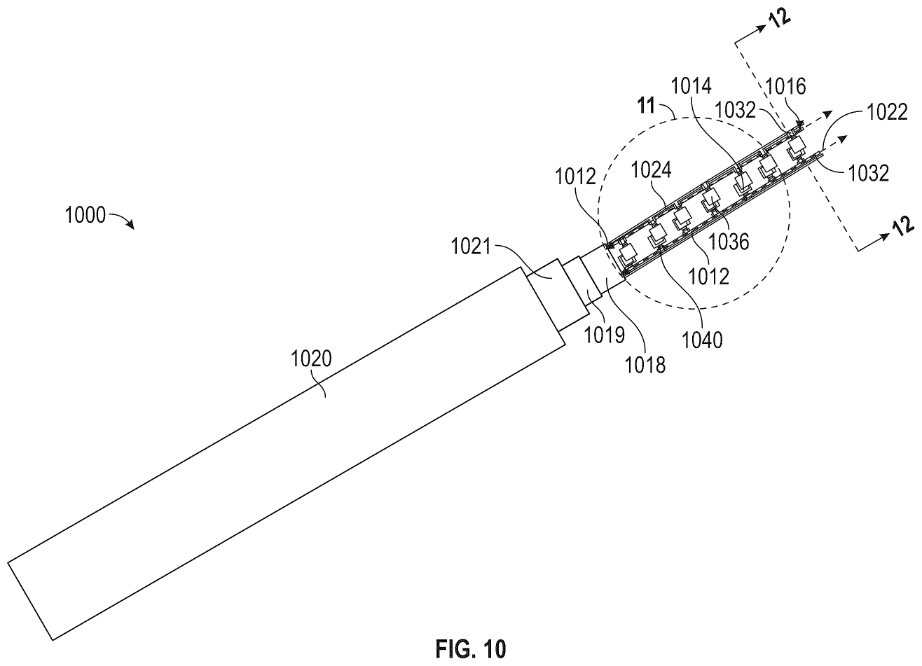

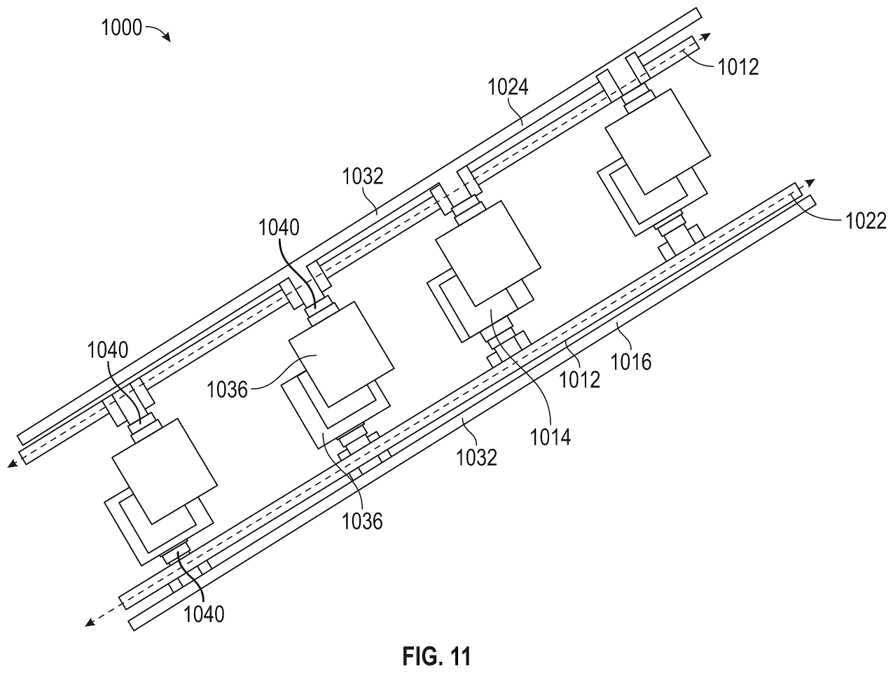

Turning now to FIGS. 10-17, in some embodiments, a heating cable can include an auto-shutoff mechanism that disconnects one or more PTC chips from wires supplying power to the PTC chips. In this regard, for example, FIGS. 10-16 illustrate another embodiment of a heating cable 1000. The heating cable 1000 of FIGS. 10-16 may generally include similar features as the heating cable 10 of FIGS. 1-7, including but not limited to first and second conductor wires 1012, PTC chips 1014, frames 1016, a primary jacket 1018, a barrier layer 1019, a final jacket 1020, a ground plane 1021, center axes 1022, stems 1024, securement tabs 1026, chip tabs, and tape 1038. Thus, discussion of the heating cable 10 above also generally applies to similarly numbered or named components of the heating cable 1000 (and vice versa).

As described above, the chip tabs 1036 can be coupled to the frame elements 1032 to create an electrical pathway between the wires 1012 and the PTC chips 1014. In some examples, the electrical pathway between the wires 1012 and the PTC chips 1014 can be advantageously severed to mitigate damage to the cable 10. For example, the frame elements 1032 can be configured to automatically disconnect from the chip tabs 1036 to disconnect the wires 1012 and the PTC chips 1014 and sever the electrical pathway therebetween. As described below, the frame elements 1032 can be automatically disconnected from the chip tabs 1036 in response to a condition, such as a predetermined temperature, current, or other condition.

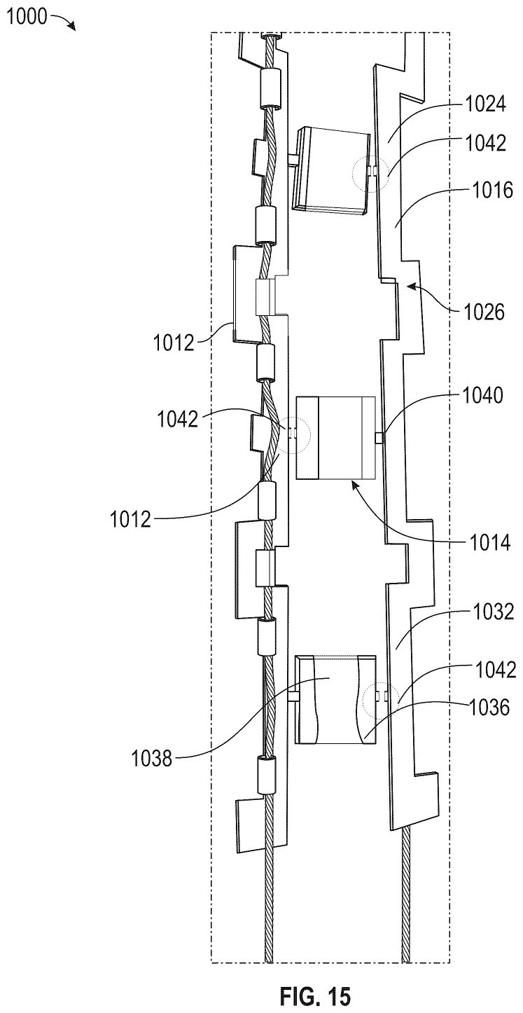

Referring to FIGS. 10-15, in some embodiments, each of the chip tabs 1036 may be coupled to the frame elements 1032 via a respective switch 1040. More specifically, the switch 1040 may be actuated to electrically and/or physically disconnect the frame elements 1032 from the chip tabs 1036 (as shown in FIG. 15), thereby severing the electrical pathway between the wires 1012 and the PTC chips 1014. Severing the electrical pathway between the wires 1012 and one or more of the PTC chips 1014 may mitigate or cease the flow of current through the one or more impacted PTC chips 1014, thus reducing or ceasing the generation of heat (e.g., thermal energy) by the one or more impacted PTC chips 1014.

In some embodiments, each switch 1040 may be actuated at a predetermined temperature to mitigate potential thermal runaway. For example, the switch 1040 may be actuated to sever the electrical pathway between the wires 1012 and the PTC chips 1014 at a predetermined temperature that is equal to or greater than about 300 degrees Celsius. In other examples, the switch 1040 may be actuated at a predetermined temperature that is greater than about 350 degrees Celsius, greater than about 325 degrees Celsius, greater than about 275 degrees Celsius, or greater than about 250 degrees Celsius.

In some examples, each switch 1040 may instead be actuated when a predetermined amount of current is flowing through the switch 1040 or the PTC chip 1014. For example, the switch 1040 may be actuated to sever the electrical pathway between the wires 1012 and the PTC chips 1014 when the current flowing through the switch 1040 or the PTC chip 1014 exceeds a predetermined value.

As illustrated in FIGS. 10-15, in some embodiments, the switch 1040 may be a solder or weld coupling between the chip tabs 1036 and the frame elements 1032 that may melt or otherwise break at or around the predetermined temperature to disconnect the chip tabs 1036 and the frame elements 1032. The switch 1040 may instead undergo any phase transition (e.g., sublimation, melting, or other phase transition), or may instead expand or contract to cause a disconnect between the chip tabs 1036 and the frame elements 1032. For example, referring again to FIGS. 10-15, the switch 1040 may be any thermal switch such as a fuse, solder, a weld, a bimetallic material, a rod and tube, or other type of thermal switch or fuse that is actuated at or around the predetermined temperature to disconnect the chip tabs 1036 and the frame elements 1032.

In some embodiments, the actuation of one of the switches 1040 may permanently disconnect the electrical path connecting the wires 1012 with one or more of the PTC chips 1014. However, in other examples, the switches 1040 may be resettable, so that the affected PTC chips 1014 can be reconnected to the wires 1012, and again allowed to generate heat.

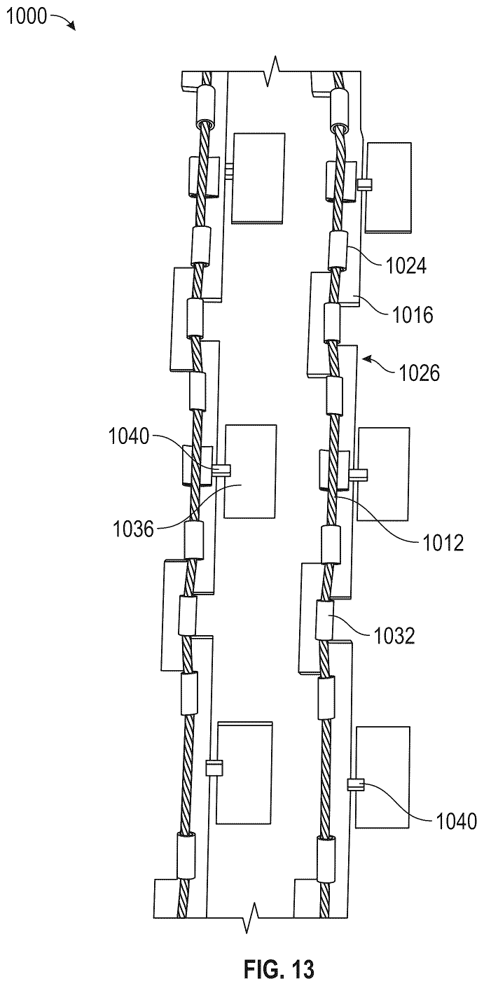

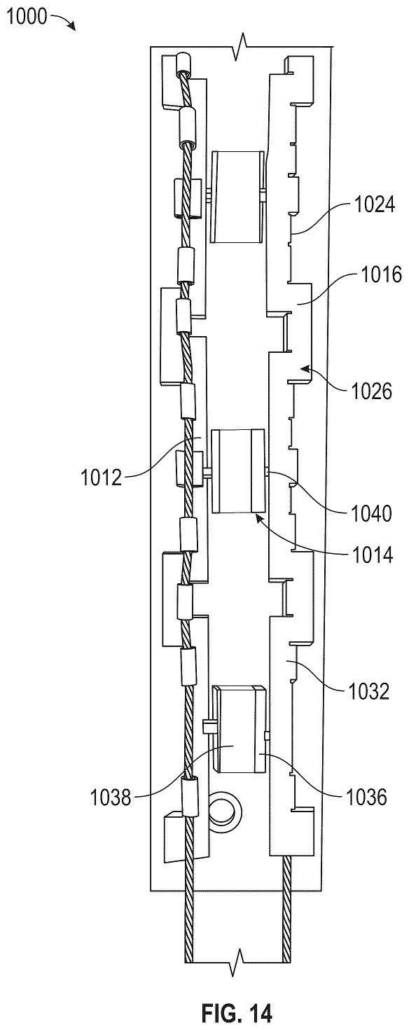

By way of example, an experiment was conducted based on the cable 1000 of FIGS. 13-15. As shown in FIG. 13, chip tabs 1036 were connected to frames 1032 via switches 1040. These switches 1040 were in the form of a high temperature solder (e.g., with a composition of 97.5% lead, 2.5% silver) with a melting point of 305 degrees Celsius. As shown in FIG. 14, the cable 1000 was partially assembled to couple PTC chips 1014 between conductor wires 12 via the chip tabs 1014. Furthermore, a tape 1038 was wrapped around the PTC chips 1014 and chip tabs 1036 to further secure the components together. After assembly, the cable 1000 was subjected to temperatures up to 310 degrees Celsius. As a result of this heat condition, switches 1040 melted, as indicated at circles 1042 shown in FIG. 15, which severed an electrical pathway between the wires 1012 and the PTC chips 1036.

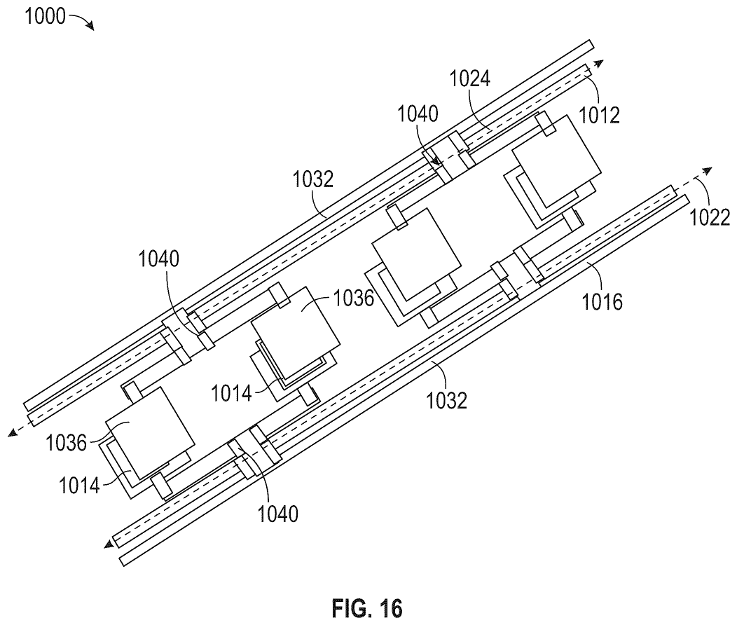

Referring briefly to FIG. 16, in some examples, each of the switches 1040 may couple more than one of the chip tabs 1036 to the frame 1016, and thus may electronically connect more than one of the PTC chips 1014 to the conductor wires 1012. For example, one or more of the switches 1040 may electronically connect two, three, four, or more of the PTC chips 1014 to the conductor wires 1012. As illustrated in FIG. 16, the PTC chips 1014 that are electronically connected to the conductor wires 1012 by a single one of the switches 1040 may be arranged electronically in parallel with one another, thereby reducing the current flowing through each of the PTC chips 1014, potentially increasing the longevity of the respective PTC chips 1014. However, in some implementations, the PTC chips 1014 may instead be connected to each other in series. Additionally, actuating the switch 1040 that electronically connects a plurality of the PTC chips 1014 to the conductor wires 1012, may disconnect each of the plurality of PTC chips 1014 electronically connected to the switch 1040.

With further reference to FIG. 16, while a severable connection between the stem 1024 and the chip tabs 1036 is collectively referred to as a switch 1040, in some implementations, each of these switches 1040 may comprise multiple fuses, solders, welds, etc. to provide multiple opportunities (e.g., “sever points”) to sever the electrical pathway in response to the set condition.

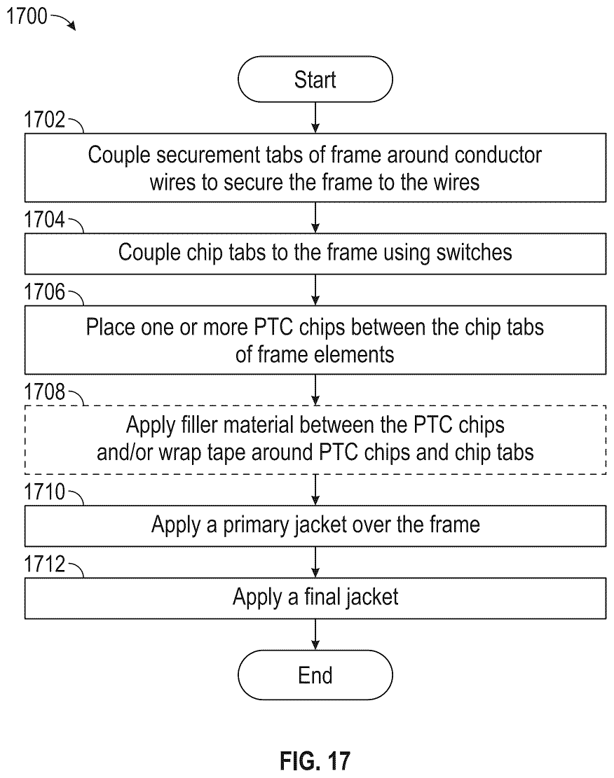

In light of the above, FIG. 17 illustrates an example method 1700 for manufacturing the cable 1000 of some embodiments. It should be noted that, while the method in FIG. 17 is shown and described as having certain method steps in a specific order, in some implementations, the method may include fewer or more steps, steps that are repeated, steps in a different order, and/or two or more steps performed simultaneously.

Referring to FIG. 17, at step 1702, the method 1700 can include coupling (e.g., via crimping, bending, or other coupling technique) securement tabs 1026 of the frame elements 1032 around parallel wires 1012 to secure (e.g., mechanically fasten) the frame 1016 to the wires 1012. For example, step 1702 may be similar to step 902 of the method 900 of FIG. 9 described above.

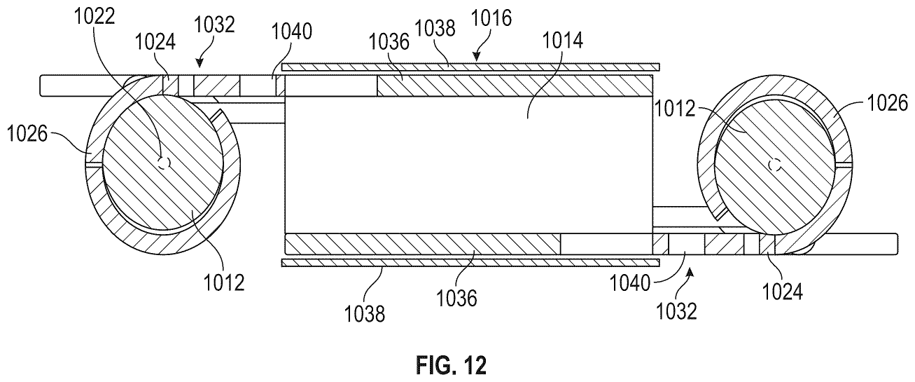

At step 1704, the method 1700 can include coupling chip tabs 1036 to the frame elements 1032 using switches 1040, as shown in FIG. 10. Step 1704 may further include arranging or mechanically manipulating the chip tabs 1036 via bending, crimping, or other mechanical means. At step 1706, the method 1700 can include placing one or more PTC chips 1014 between the chip tabs 1036 of the frame elements 1032, as shown in FIGS. 10-15. During step 1706, the chip tabs 1036 of the frame elements 1032 may be further adjusted and aligned so that the chip tabs 1036 can properly retain the PTC chips 1014. In some embodiments, steps 1702-1706 can be completed in an assembly line-type operation. At step 1708, the method 1700 can optionally include applying silicone or another filler material in the spacing between PTC chips 1014. Furthermore, step 1708 can optionally or additionally include wrapping the chip tabs 1036 and embedded PTC chips 1014 with a Kapton tape 1038 (or a polyimide tape, or another heat resistant tape), as shown in FIGS. 12 and 15.

At step 1710, the method 1700 can include applying a primary jacket 1018 over the frame 1016. For example, during step 1710, the primary jacket 1018 can be a tape or other wrappable material that is wrapped around the frame 1016. At step 1712, the method 1700 can include applying a final jacket 1020. For example, during step 1712, the assembly including at least the wires 1012, the PTC chips 1014, the frame 1016, and the primary jacket 1018 can be pulled through the final jacket 1020. In some applications, prior to step 1712, the method 1700 can further include applying a barrier layer 1019 (e.g., metallic foil) and/or a ground plane layer 1021 (e.g., metallic braid or wrap) around the primary jacket 1018.

Once manufactured, any of the cables 10, 1000 described herein can be installed in an environment and connected to a voltage source (not shown). For example, the cable 10, 1000 can be cut to length to fit a component or surface to be heated. Once installed, a voltage (e.g., from the voltage source) can be applied across the conductor wires 12, 1012, and therefore across the PTC chips 14, 1014, to generate heat.

Furthermore, with respect to the cable 100, during operation, one or more of the switches 1040 can be actuated to disconnect one or more of the chip tabs 1036 from the frame elements 1032 when the switch 1040 is exposed to a predetermined temperature (or current). This “auto shut-off” of the PTC chip 1014 (via the disconnected chip tab 36) at the high-temperature location by the switch 1040 can prevent the particular PTC chip 1014 from overheating, yet allow continued overall operation of the cable 1000. That is, the cable 1000 may continue to operate, though will not generate heat at the location (“node”) of the disconnected PTC chip 1014. As noted above, as the PTC chips 1014 may be spaced apart between about 0.5 inches and about eight inches, the cable 1000 can continue to heat a component or surface despite losing the node. This can allow continued operation of the cable 1000 without thermal runaway causing damage to the surface or component that the cable 1000 is heating.

While the above cables 10, 1000 are described as self-regulating heating cables, e.g., including a ceramic PTC chip 14, 1014, in some embodiments, the concepts described herein can apply to a constant wattage heating cable. For example, in such embodiments, the cable 10, 1000 can include a constant wattage chip in place of the PTC chip 14, 1014.

While the structures and components disclosed herein may be embodied in many different forms, several specific embodiments are discussed herein with the understanding that the embodiments described in the present disclosure are to be considered only exemplifications of the principles described herein, and the disclosure is not intended to be limited to the embodiments illustrated. Throughout the disclosure, the terms “about” and “approximately” mean plus or minus 5% of the number that each term precedes, inclusive. Similarly, as used herein with respect to a reference value, the term “substantially equal” (and the like) refers to variations from the reference value of less than ±5% (e.g., ±2%, ±1%, ±0.5%) inclusive.

Unless otherwise limited or defined, “substantially parallel” indicates a direction that is within ±12 degrees of a reference direction (e.g., within ±6 degrees or ±3 degrees), inclusive. Correspondingly, “substantially vertical” indicates a direction that is substantially parallel to the vertical direction, as defined relative to gravity, with a similarly derived meaning for “substantially horizontal” (relative to the horizontal direction). Likewise, unless otherwise limited or defined, “substantially perpendicular” indicates a direction that is within ±12 degrees of perpendicular a reference direction (e.g., within ±6 degrees or ±3 degrees), inclusive. Likewise, unless otherwise limited or defined, “substantially radial” indicates a direction that is within ±12 degrees of radial a reference direction (e.g., within ±6 degrees or ±3 degrees), inclusive. Likewise, unless otherwise limited or defined, “substantially axial” indicates a direction that is within ±12 degrees of axial a reference direction (e.g., within ±6 degrees or ±3 degrees), inclusive.

Also as used herein, unless otherwise limited or defined, “substantially identical” indicates that features or components are manufactured using the same processes according to the same design and the same specifications. In some cases, substantially identical features can be geometrically congruent.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Unless otherwise specifically indicated, ordinal numbers are used herein for convenience of reference, based generally on the order in which particular components are presented in the relevant part of the disclosure. In this regard, for example, designations such as “first,” “second,” etc., generally indicate only the order in which a thus-labeled component is introduced for discussion and generally do not indicate or require a particular spatial, functional, temporal, or structural primacy or order.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A self-regulating heating cable comprising:
a first conductive wire;
a second conductive wire;
a first frame element coupled to the first conductive wire, and including a first chip tab that extends from the first frame element toward the second conductive wire at least to a midpoint between the first and second conductive wires;
a second frame element coupled to the second conductive wire, and including a second chip tab that extends from the second frame element toward the first conductive wire; and
a ceramic positive temperature coefficient (PTC) chip disposed between the first conductive wire and the second conductive wire,
wherein the PTC chip is retained between the first conductive wire and the second conductive wire by the first chip tab and the second chip tab.

2. The self-regulating heating cable of claim 1, wherein the first chip tab includes a plurality of first chip tabs,
wherein the second chip tab includes a plurality of second chip tabs,
wherein the PTC chip includes a plurality of PTC chips, and
wherein each of the plurality of PTC chips is retained by a respective one of the plurality of first chip tabs and a respective one of the plurality of second chip tabs.

3. The self-regulating heating cable of claim 2, wherein the plurality of first chip tabs are spaced equidistantly along the first frame element.

4. The self-regulating heating cable of claim 2, wherein the first frame element includes a stem that extends along the first conductive wire between two or more of the plurality of first chip tabs.

5. The self-regulating heating cable of claim 1, wherein the first frame element further includes first and second securement tabs to couple the first frame element to the first conductive wire, the first securement tab being axially offset from the second securement tab along a first axis extending through a center of the first conductive wire.

6. The self-regulating heating cable of claim 1, wherein the first frame element, the first chip tab, the second frame element, and the second chip tab each comprise an electrically conductive material and provide an electrical pathway between the first and second conductive wires and the ceramic PTC chip.

7. The self-regulating heating cable of claim 1, further comprising:
a primary jacket that surrounds the first frame element and the second frame element; and
a final jacket that surrounds the primary jacket.

8. The self-regulating heating cable of claim 1, wherein the first frame element automatically disconnects from the first chip tab to disconnect the PTC chip from the first conductive wire, in response to a condition.

9. The self-regulating heating cable of claim 8, wherein a switch couples the first frame element to the first chip tab and automatically disconnects the first frame element from the first chip tab based on one or more of the conditions including:
a temperature of the PTC chip; and
an amount of current flowing through the PTC chip.

10. A self-regulating heating cable comprising:
a first conductive wire;
a second conductive wire;
a first frame element coupled to the first conductive wire, and including a first chip tab;
a second frame element coupled to the second conductive wire, and including a second chip tab; and
a ceramic positive temperature coefficient (PTC) chip disposed between and electrically coupled to the first conductive wire and the second conductive wire,
wherein the PTC chip is retained between the first conductive wire and the second conductive wire by the first chip tab and the second chip tab, and
wherein the first or second chip tab automatically electrically disconnects from the first or second frame element, respectively, in response to a condition.

11. The self-regulating heating cable of claim 10, further comprising a switch that couples the first chip tab to the first frame element,
wherein the switch automatically decouples the first chip tab from the first frame element in response to the condition.

12. The self-regulating heating cable of claim 10, wherein the condition that causes the first or second chip tab to disconnect from the first or second frame element, respectively, includes one or more of:
a temperature of the PTC chip; and
an amount of current flowing through the PTC chip.

13. The self-regulating heating cable of claim 10, further comprising a first axis extending through a center of the first conductive wire,
wherein the first frame element further includes first and second securement tabs that couple the first frame element to the first conductive wire, and
wherein the first securement tab is axially offset from the second securement tab along the first axis.

14. The self-regulating heating cable of claim 10, wherein the first frame element, the first chip tab, the second frame element, and the second chip tab each comprise an electrically conductive material and provide an electrical pathway between the first and second conductive wires and the ceramic PTC chip.

15. The self-regulating heating cable of claim 10, wherein the first chip tab includes a plurality of first chip tabs spaced along the first frame element, and
wherein the plurality of first chip tabs help retain a plurality of PTC chips.

16. The self-regulating heating cable of claim 15, wherein the first frame element includes a stem that extends along the first conductive wire between two or more of the plurality of first chip tabs.

17. A method of producing a self-regulating heating cable for use with an alternating current (AC) source, the method comprising:
aligning a first frame element along a first conductive wire, the first conductive wire including a first axis extending through a center thereof;
aligning a second frame element along a second conductive wire that is positioned parallel to the first conductive wire;
coupling the first frame element to the first conductive wire;
coupling the second frame element to the second conductive wire;
arranging a first chip tab of the first frame element to extend from the first frame element toward the second conductive wire at least to a midpoint between the first and second conductive wires;
arranging a second chip tab of the second frame element to extend from the second frame element toward the first conductive wire at least to the midpoint between the first and conductive second wires; and
placing a ceramic positive temperature coefficient (PTC) chip between the first and second chip tabs of the first and second frame elements.

18. The method of claim 17, further comprising arranging a switch along the first frame element, the switch to automatically disconnect an electrical pathway between the PTC chip and the first conductive wire in response to one or more of:
a temperature of the PTC chip; and
an amount of current flowing through the PTC chip.

19. The method of claim 17, further comprising providing an electrical pathway between the first and second conductive wires and the ceramic PTC chip through the first frame element, the second frame element, the first chip tab, and the second chip tab.

20. The method of claim 17, wherein coupling the first frame element to the first conductive wire includes securing first and second securement tabs of the first frame element to the first conductive wire, the first securement tab being axially offset from the second securement tab along the first axis.
